(19) United States
(12) Patent Application Publication
(10) Pub. No.: US 2001/0029633 A1
(43) Pub. Date: Oct. 18, 2001

(54) Hammerhead with nail straightening holes

(76) Inventor: Ray Johnson, Wichita, KS (US)

Correspondence Address: EDWIN H. CRABTREE, SUITE 575, 3773 CHERRY CREEK N. DR., DENVER, CO, 80209, US

(21) Appl. No.: 09/757,892

(22) Filed: Jan. 10, 2001

Related U.S. Application Data
(60) Provisional application No. 60/175,237, filed on Jan. 10, 2000.

(51) Int. Cl. B25D 1/04

(52) U.S. Cl. 7/146

(57) ABSTRACT

A hammerhead with handle used for straightening various types of nails and other types of fasteners. The hammerhead with handle provides sufficient leverage to quickly grip and straighten a nail. The hammerhead includes a head member with a front portion and a rear portion. A pair of claws extend outwardly from the rear portion of the head member. A nose extension extends outwardly from the front portion of the head member. A nose is attached to the nose extension. The nose includes a nail striking face for hitting a head of the nail. When the claws are held upwardly and the nose facing downwardly, the hammerhead includes a vertical “Y” axis. The “Y” axis is disposed along a length, in a range of 5 to 6 inches, of the hammerhead from the end of the claws, through the head member to the nail striking face. The hammerhead also includes a horizontal “X” axis through a width, in a range of ¾ to 1 inch, of the head member and a horizontal “Z” axis at a right angle to the “X” axis. The head member includes a first head member hole therein and disposed along the “X” axis. The head member also includes a second head member hole therein and disposed along the “Z” axis. The nose includes a nose hole therein. A length of the nose hole is parallel to the “Z” axis. The holes are used for receiving the head of a bent nail.

This application is based on an earlier filed provisional application filed in the U.S. Patent and Trademark Office on Jan. 10, 2000 and having Ser. No. 60/175,237.

### BACKGROUND OF THE INVENTION

(a) Field of the Invention

This invention relates to nail hammers and more particularly, but not by way of limitation, to a hammerhead with handle. The hammerhead having one or more holes therein for engaging a head of a bent nail and straightening the nail.

(b) Discussion of Prior Art

In U.S. Pat. No. 561,072 to Burns, a wire bending tube, used for bending wire, is shown attached to a side of a claw hammer head. In U.S. Pat. No. 1,235,084 to Weigel, a tube is shown for straightening nails. The tube is part of a side of a claw hammer head. In U.S. Pat. No. 1,362,797 to Hose, a claw hammerhead is illustrated having a nose with a wire hole therethrough. The hole in the nose is used for helping join and splice wire together. In U.S. Pat. No. 4,732,058 to Chung, a measuring hammer is described having a hole for receiving the head of a nail therein.

None of the above mentioned patents specifically disclose or teach the use of holes in a head member or a nose of a hammerhead wherein the holes are used for receiving a head of a bent nail. The hammerhead and handle used for straightening the bent nail and like fasteners.

### SUMMARY OF THE INVENTION

In view of the foregoing, it is a primary object of the subject invention to provide a hammerhead having one or more holes therein for receiving and straightening a bent nail. The hammerhead can be used with a claw hammer, a mallet, a sledge hammer and other types of hammers and without destroying the strength and integrity of the hammerhead and it's function.

Another object of the invention is the hammerhead and handle can be used to provide sufficient leverage to straighten the nail and then continue to drive the nail into a surface or remove the nail for reuse. The hammerhead is designed without requiring any attachments to the hammer.

Still another object of the hammerhead is the holes therein can be used for straightening different types of fasteners such as screws, brads, tacks, bridge spikes, concrete reinforcing bar, different sizes and shapes of nails and the like.

Yet another object of the hammerhead is the diameter of the holes are adapted to quickly receive the head of a bent nail therein prior to straightening the nail. The diameter of the holes may vary for different sizes of nail heads.

The hammerhead includes a head member with a front portion and a rear portion. A pair of claws extend outwardly from the rear portion of the head member. A nose extension extends outwardly from the front portion of the head member. A nose is integrally attached to the nose extension. The nose includes a nail striking face for hitting a head of the nail.

When the claws are held upwardly and the nose facing downwardly, the hammerhead includes a vertical “Y” axis. The “Y” axis is disposed along a length, in a range of 5 to 6 inches, of the hammerhead from the end of the claws, through the head member to the nail striking face. The hammerhead also includes a horizontal “X” axis through a width, in a range of ¾ to 1 inch, of the head member and a horizontal “Z” axis at a right angle to the “X” axis. The head member includes a first head member hole therein and disposed along the “X” axis. The head member also includes a second head member hole therein and disposed along the “Z” axis. The nose includes a nose hole therein. A length of the nose hole is parallel to the “Z” axis. The holes are used for receiving the head of a bent nail.

These and other objects of the present invention will become apparent to those familiar with the different types of hammers, hammerheads and hand tools used for driving nails and the like into a surface when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments of the present invention according to the best modes presently devised for the practical application of the principles thereof, and in which:

FIG. 1A is a perspective view of a hammerhead with a head member attached to one end of a handle. The hammerhead includes outwardly extending claws and a nose. The head member and nose include holes therein for receiving a head of a bent nail.

FIG. 1B is a side view of the hammerhead shown in FIG. 1A. In this view, an upper portion of the bent nail is shown received inside a nose hole in the nose of the hammerhead.

FIG. 2A is a perspective view of a hammerhead with a head member with one end of a handle integrally formed into a lower portion of the hammerhead. The hammerhead includes a head member with a first head member hole disposed along a horizontal “X” axis and a second head member hole disposed along a horizontal “Z” axis.

FIG. 2B is a side view of the hammerhead shown in FIG. 2A. In this view, an upper portion of a bent nail is shown received inside the second head member hole.

FIG. 3 is a perspective view of the hammerhead illustrating a portion of the bent nail received through the first head member hole with the hammerhead handle rotated for straightening the nail on a surface of a wooden board.

FIG. 4 is a perspective view of a nail striking face of the nose of the hammerhead being used to drive the straightened nail into the wooden board.

FIG. 5 is a perspective view of a sledge hammerhead with hollow pipe handle. The sledge hammerhead having an enlarged spike hole therein for straightening and removing spikes and/or straightening concrete rebar.

FIG. 6 is a front view of a lower portion of the hollow pipe handle used for straightening a spike driven into a wooden board.

FIG. 7 is a front view of the sledge hammerhead with spike hole received around a portion of a spike. A vice grip is shown holding the spike next to the hammerhead. The hammerhead used for removing the spike from a wooden board.

### DESCRIPTION OF THE PREFERRED EMBODIMENTS

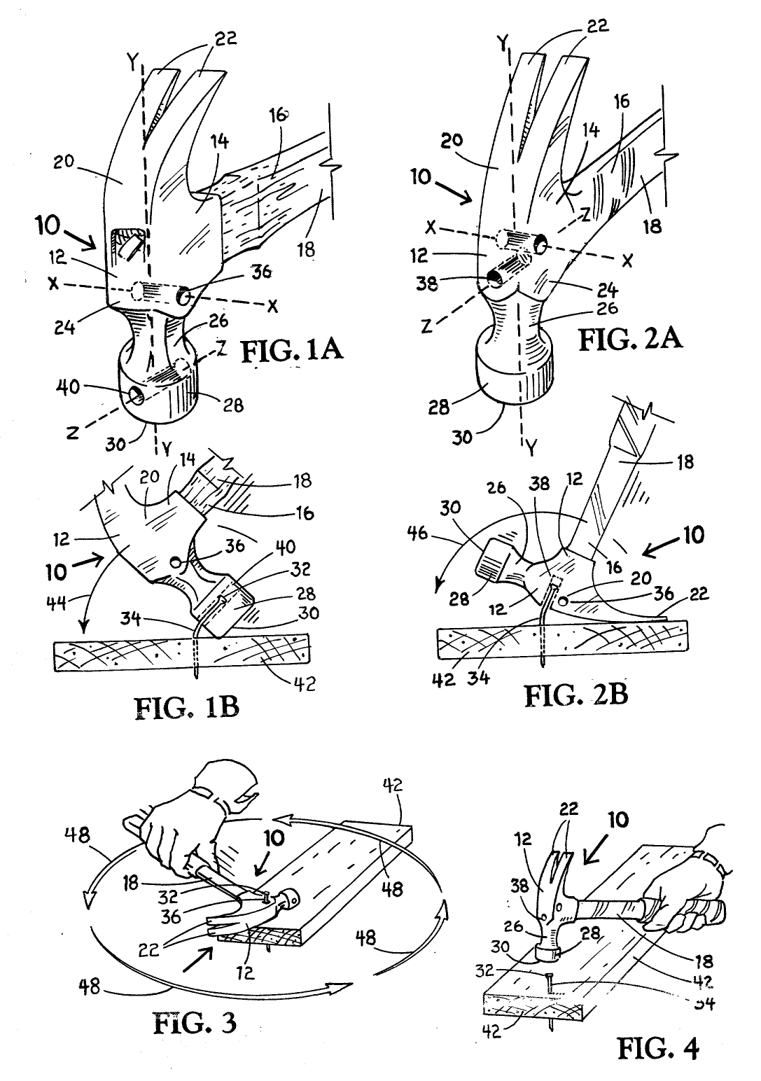

In FIG. 1A, a perspective view of a hammerhead is shown having general reference numeral 10. The hammerhead 10 includes a head member 12 having a lower portion 14 attached to one end 16 of a handle 18. The head member 12 includes a rear portion 20 integrally attached to a pair of outwardly extending claws 22. Also, the head member 12 includes a front portion 24 integrally attached to a nose extension 26 having a hammer nose 28. The nose 28 includes a nail striking face 30 used for striking a nail head 32 of a nail 34. The nail 34 and nail head 32 are shown in FIGS. 1B, 2B, 3 and 4.

When the claws 22 are held upwardly and the nose 28 facing downwardly as shown in FIGS. 1A and 2A, the hammerhead 10 includes a vertical “Y” axis. The “Y” axis is disposed along a length, in a range of 5 to 6 inches, of the hammerhead 10 from the end of the claws 22, through the head member 12 to the nail striking face 30. The hammerhead 10 also includes a horizontal “X” axis through a width, in a range of ¾ to 1 inch, of the head member 12 and a horizontal “Z” axis at a right angle to the “X” axis.

The head member 12 includes a first head member hole 36 through the width of the head member 12 and disposed along the “X” axis. The head member 12 also includes a second head member hole 38 therein and disposed along the “Z” axis. The second head member hole 38 is shown in FIG. 2A. The nose 28 includes a nose hole 40 through the width of the nose. A length of the nose hole 40 is parallel to the “Z” axis. Obviously, the holes 36, 38 and 40 are used for receiving different shapes and sizes of nail heads and a portion of the nail therein. As mentioned above, the diameter of the holes may vary depending on the size and shape of the various types of fasteners being straightened. Also, the holes in the hammerhead 10 are formed therein without destroying the integrity and strength of the hammer.

In FIG. 1B, a side view of the hammerhead 10 is shown. In this view, an upper portion of a bent nail 34 and nail head 32 is shown received inside the nose hole 40 in the nose 28 of the hammerhead 10. A portion of the nail 34 has been driven into a wooden board 42 and then bent. In this view, the leverage of hammerhead 10 and the handle 18 is shown in operation as the handle is pivoted counterclockwise, as indicated by arrow 44, on top of the wooden board 42 for straightening the nail 34.

In FIG. 2A, a perspective view of the hammerhead 10 is shown with the head member 12 integrally formed into the end 16 of the handle 18. In this drawing, the head member 12 is shown with the first head member hole 36 disposed along the “X” axis and the second head member disposed along the “Y” axis. Obviously, depending on the position of the bent nail 34 on a surface, the user of the hammerhead 10 may elect to use either the first head member hole 36, the second head member hole 38 or the nose hole 40. In this drawing, the hammerhead 10 does not include a nose hole 40.

In FIG. 2B, a side view of the hammerhead 10 is illustrated. A portion of a bent nail 34 and nail head 32 is shown received inside the second head member hole 38 of the hammerhead 10. A portion of the nail 34 has been driven into the wooden board 42 and then bent. In this view, the leverage of hammerhead 10 and the handle 18 is shown in operation as the handle is pivoted counterclockwise, as indicated by arrow 46, on top of the wooden board 42 for straightening the nail 34.

In FIG. 3, a perspective view of the hammerhead 10 is shown illustrating a portion of the bent nail 34 received through the first head member hole 36. In this example, the hammerhead handle 18 is rotated in a counterclockwise direction, as indicated by arrows 48, for straightening the nail 34 on the surface of a wooden board 42.

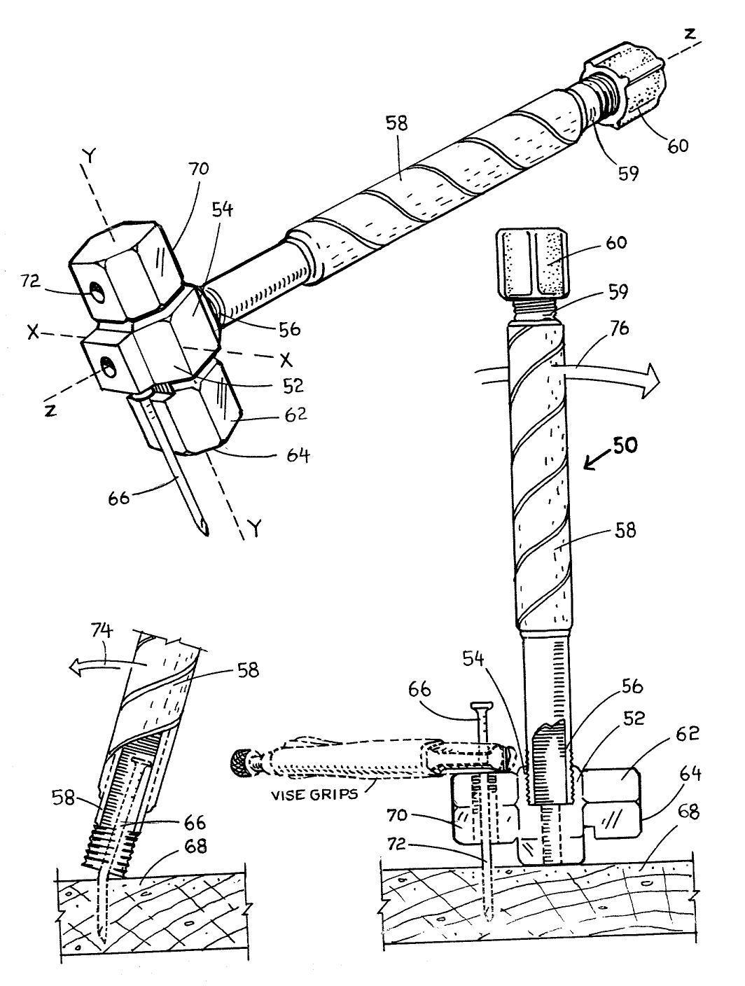

In FIG. 4, a perspective view of the hammerhead 10 and handle 18 are shown after the hammerhead has been used to straighten the nail 34. In this drawing, the nail striking face 30 of the nose 28 is shown just prior to hitting the nail head 32 of the straightened nail 34 into the wooden board 42.

In FIG. 5, a perspective view of another embodiment of the subject invention is shown with a sledge hammerhead having general reference numeral 50. The sledge hammerhead 50 includes a head member 52 having a lower portion 54 attached to one end 56 of a hollow pipe handle 58. An opposite end 59 of the pipe handle 58 is threaded to a removable end cap 60. The hollow pipe handle 58 is shown in FIG. 5 disposed along a length of a “Z” axis. The head member 52 includes a front portion 62 with a fastener striking face 64 used for striking large nails, spikes and the like. A spike 66 is shown received on top of the front portion 62 of the head member 52 and positioned for driving into a wooden board 68. The wooden board 68 is shown in FIGS. 6 and 7. A rear portion 70 of the hammerhead 50 includes an enlarged spike hole 72 therein. The length of the spike hole 72 in the rear portion 70 is parallel to the length of the hollow pipe handle 58. The spike hole 72 is used for straightening and removing spikes and/or straightening concrete rebar. While the spike hole 72 is shown in the rear portion 70 of the hammerhead 50, it can also be located in various positions on the head member 52. Also if desired, a second spike hole can be located in the front portion 62 of the head member 52 with the length of the second spike hole parallel to the length of the handle 58.

In FIG. 6, a front view of a portion of the hollow pipe handle 58 is shown and used for straightening a spike 66 driven into the wooden board 68. The end cap 60 has been removed from the opposite end 59 of the handle 58 and a portion of the hollow handle 58 inserted around the spike 66. By rotating the handle 58 in a counterclockwise direction, as indicated by arrow 74, the spike 66 is straightened on the board 68.

In FIG. 7, a front view of the sledge hammerhead 50 is shown with the spike hole 72 received around a portion of the spike 66. A vice grip 76 is shown in this drawing and holding the spike 66 next to the head member 52. In this example, the hammerhead 50 is used for removing the spike 66 from the wooden board 68 by rotating the hollow pipe handle 58 in a clockwise direction as indicated by arrow 76.

While the invention has been shown, described and illustrated in detail with reference to the preferred embodiments and modifications thereof, it should be understood by those skilled in

The embodiments of the invention for which an exclusive privilege and property right is claimed are defined as follows:

1. A hammerhead with handle used for straightening various types of nails and fasteners, the hammerhead comprising:
a head member with a front portion and a rear portion;
a nose extension extends outwardly from the front portion of said head member;
a nose attached to said nose extension, said nose including a nail striking face; and
a first head member hole disposed in said head member, said first head member hole adapted for receiving a portion of the nail to be straightened therein.

2. The hammerhead as described in claim 1 further including a second head member hole disposed in said head member, said second head member hole adapted for receiving a portion of the nail to be straightened therein.

3. The hammerhead as described in claim 1 further including a nose hole disposed in said nose, said nose hole adapted for receiving a portion of the nail to be straightened therein.

4. A hammerhead with handle used for straightening various types of nails and other types of fasteners, the hammerhead comprising;
a head member with a front portion and a rear portion;
a nose extension extends outwardly from the front portion of said head member;
a nose attached to said nose extension, said nose including a nail striking face; and
a first head member hole disposed in said head member, said first head member hole adapted for receiving a portion of the nail to be straightened therein;
whereby the hammerhead, when said nose is pointed downwardly, includes a vertical “Y” axis, the “Y” axis disposed along a length of the hammerhead, the hammerhead also includes a horizontal “X” axis through a width of the hammerhead and a horizontal “Z” axis at a right angle to the “X” axis, said first head member hole parallel to the “X” axis.

5. The hammerhead as described in claim 4 further including a second head member hole disposed in said head member, said second head member hole adapted for receiving a portion of the nail to be straightened therein, said second head member hole parallel to the “Z” axis.

6. The hammerhead as described in claim 4 further including a nose hole disposed in said nose, said nose hole adapted for receiving a portion of the nail to be straightened therein, a length of said no se hole parallel to the “Z” axis.

7. A hammerhead used for straightening various types of nails and other types of fasteners, the hammerhead comprising:
a head member with a front portion and a rear portion;
a fastener striking face on the front portion of said head member;
a hollow pipe handle having one end of said pipe handle attached to said head member;
a first spike hole disposed in said head member, said spike hole adapted for receiving and straightening a portion of a large fastener thereon;

8. The hammerhead as described in claim 7 wherein a length of said first spike hole in said head member is parallel to the length of said hollow pipe handle.

9. The hammerhead as described in claim 7 further including a removable end cap attached to an opposite end of said hollow pipe handle, wherein when said end cap is removed, the opposite end of said hollow pipe handle is adapted for receipt around a portion of a bent fastener.

10. The hammerhead as described in claim 7 further including a second spike hole located in the front portion of said head member.

11. The hammerhead as described in claim 7 wherein a length of said second spike hole in said head member is parallel to the length of said hollow pipe handle.
